(19) United States
(12) Patent Application Publication
(10) Pub. No.: US 2010/0296928 A1
(43) Pub. Date: Nov. 25, 2010

(54) Wind turbine accelerator panels and method of making same

(76) Inventors: Andrew J. Falcone, Winsted, CT (US); David Hinman Leach, Torrington, CT (US); James N. Streeter, Torrington, CT (US)

Correspondence Address: TED PAULDING, 10 PENWOOD LA, WETHERSFIELD, CT, 06109, US

(21) Appl. No.: 12/454,823

(22) Filed: May 21, 2009

(51) Int. Cl. E04C 2/30; E04C 2/34; F03D 1/02; B32B 37/02; F03D 9/00

(52) U.S. Cl. 416/120; 52/249; 156/285; 290/55

(57) ABSTRACT

A vertically sectioned cylindrical accelerator for mounting pairs of wind turbines respectively on opposite sides thereof has a covering of twin-sheet thermoformed plastic panels which are smooth on the outside but carry a multiplicity of small cone-shaped projections on their interior surface. The panels are mounted on a structural member by a single central bolt for free expansion and contraction with variation in ambient temperature. The panels are manufactured in a twin-sheet thermoforming operation wherein one sheet is maintained with a smooth surface and the second sheet is provided with the cone-shaped projections, the two sheets being fused together to form an integral panel of lightweight and high strength characteristics.

### BACKGROUND OF THE INVENTION

Wind turbine electrical generating systems have employed various accelerators for initially engaging the wind and directing the same in two diverging streams of air to a pair of wind turbines mounted on opposite sides of the accelerators. As will be apparent, a covering for an accelerator should be lightweight and of high structural integrity with a smooth continuous external surface for efficient interaction with the wind. Sheet steel has been used in the past for the external covering on accelerators but requires a coating to withstand the elements and is relatively heavy and expensive. Other materials have also been employed but have not been wholly successful.

It is the general object of the present invention to provide large monolithic thermoformed twin-sheet plastic panels which are light in weight but which exhibit a high degree of structural integrity and are ideally suited for use as external wind engaging covering on accelerators.

A further object resides in the provision of a mounting system for the panels, which is simplified and yet highly effective in preventing rotation or other dislodgement of the panels from an accelerator.

Still another object resides in the provision of means for accommodating the substantial expansion and contraction of panels due to ambient temperature variation while maintaining smooth continuous exterior joint areas between panels and thus avoiding drag on the wind passing thereover.

Finally, still another object resides in providing an improved method of manufacture for the panels using a minimum of thermoplastic material for light weight and yet providing panels of the necessary high degree of structural integrity.

### SUMMARY OF THE INVENTION

In fulfillment of the foregoing objects and in accordance with the present invention a tower is provided for supporting wind turbines at elevated positions for enhanced wind velocities. An accelerator is mounted on the tower and has a gradually arcuate front surface adapted to divide wind impinging thereon into a pair of discrete diverging streams of air flowing around opposite sides thereof to a pair of wind turbines rotatable about substantially parallel horizontal axes on opposite sides of the accelerator.

The detailed configuration of one or more accelerators and wind turbines on the tower may vary widely but in presently preferred form a vertically elongated generally cylindrical accelerator system which may be constructed in sections is provided with a number of pairs of wind turbines mounted thereon as shown and described in co-pending U.S. patent application Ser. No. 12/286054 entitled WIND TURBINE GENERATING SYSTEM WITH ACCELERATOR MOUNTING PLURALITY OF BYPASS WIND TURBINES, filed Sep. 26, 2008, and invented by Russel H. Marvin and David A. Leach, hereby incorporated herein by reference.

U.S. patent application Ser. No. 12/077556 to Russel H. Marvin, entitled ACCELERATOR FOR USE IN A WIND POWER ELECTRCAL GENERATING SYSTEM FILED Mar. 20, 2008, hereby incorporated herein by reference, is also of interest in showing relatively complex contoured plastic covering for individual accelerators which is however quite different from that of the present invention and which is applied to a completely different type of accelerator.

The accelerator of the present invention supports a multiplicity of similar large monolithic panels of lightweight thermoformed construction arranged in vertically stacked horizontal rows. Each panel is gradually arcuate and convex facing outwardly and is secured in position by a single small centrally located bolt. Thus, lateral expansion and contraction due to temperature variation is readily accommodated. Further, each panel has narrow elongated edge portions of substantially reduced thickness in overlapping relationship with all four adjacent panels to accommodate relative sliding action during panel expansion and contraction thus minimizing any departure from a smooth and continuous wind engaging external surface.

The panels are manufactured with a multiplicity of small strength enhancing projections on their interior surfaces and with a slightly more severe curvature than required when mounted on their supporting structure. Thus, they are flexed toward a lesser degree of curvature when mounted and their side edge portions are urged into tight engagement with supporting structure and with each other for smooth airflow thereover. Further, an open-ended vertical notch is provided centrally on the interior surface of each panel for receiving a vertical structural supporting member in tight engagement therewith. Preferably, small projections on opposing notch walls engage the structural member and provide for a press fit further insuring that accidental or unintended relative rotation of the panel will not occur. Still further, additional open-ended vertical notches may be provided at each end of each panel for engagement with other vertical structural members and further support of the panels.

Finally, an improved method for manufacturing the panels of the invention is provided. A pair of similar parallel sheets of thermoplastic is provided and thermoformed in a “twin-sheet” operation, so that a first sheet has a smooth continuous exterior surface and a second sheet has a multiplicity of small strengthening projections on a side opposite the first sheet. The second sheet is simultaneously fused with the first sheet to result in an integral unitary panel, which is lightweight, and yet exhibits a high degree of structural integrity. In fact, the method employed is believed to produce the highest possible ratio of strength to weight in plastic panel construction.

### DESCRIPTION OF THE DRAWINGS

FIG. 1 is a perspective view showing a portion of a wind turbine tower with a cylindrical accelerator mounted thereon and having an external covering comprising a multiplicity of the panels of the present invention,

FIG. 2 is a plan view of a single panel of the invention,

FIG. 3 is a fragmentary enlarged side view of the FIG. 2 panel,

FIG. 4 an exploded side view of a panel and associated structural members prior to mounting the panel on the members,

FIG. 5 is a fragmentary exploded and enlarged side view showing the panel and structural members of FIG. 3,

FIG. 6 is further enlarged view in perspective and showing edge portions of a pair of panels,

FIG. 7 is a side view similar to FIG. 3 but showing a panel partially attached to a structural member,

FIG. 8 is a fragmentary enlarged exploded side view similar to FIGS. 4 and 7 showing a panel partially attached to a structural member,

FIG. 9 is an enlarged vertical cross sectional view of a panel taken through a central portion thereof,

FIG. 10 is a perspective view in cross section taken through a central portion of a panel,

FIG. 11 is an enlarged cross sectional view through an overlapping vertical joint between panels,

FIG. 12 is a cross sectional view through an open thermoforming mold for the panels,

FIG. 13 is a fragmentary enlarged view through a portion of the mold of FIG. 12,

FIG. 14 is a view similar to FIG. 12 but showing the mold closed,

FIG. 15 is a fragmentary side view of a cylindrical accelerator having a plurality of vertically stacked sections, and

FIG. 16 is an enlarged sectional view taken as illustrated at 16-16 in FIG. 15 and showing a joint panel and its mounting means.

### DESCRIPTION OF PREFERRED EMBODIMENT

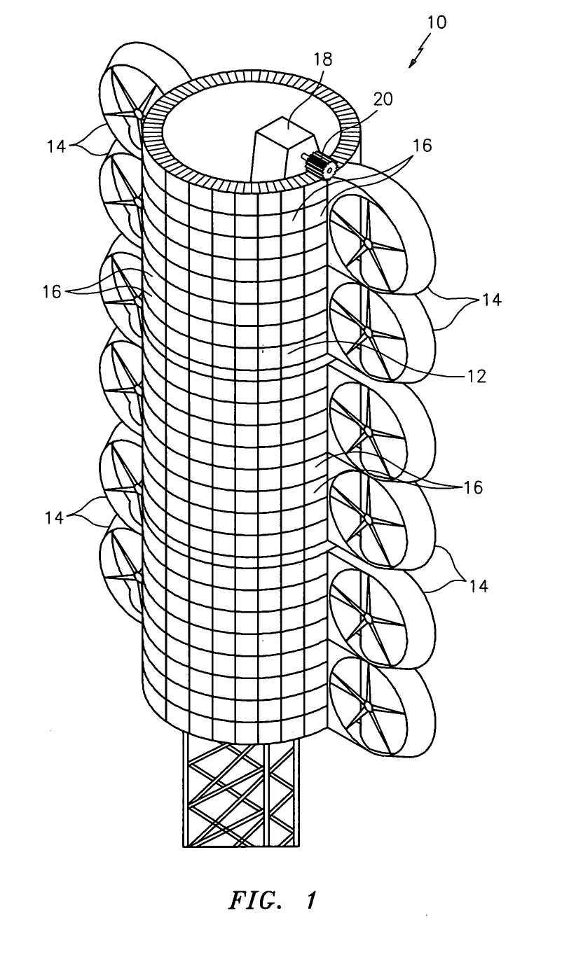

Referring particularly to FIG. 1 a wind turbine tower is indicated generally at 10 and has a vertically elongated cylindrical accelerator 12 mounted thereon. The accelerator 12 supports six 6 pairs of wind turbines 14,14 but as stated, it will be apparent that the present invention is applicable to a wide variety of accelerator and turbine systems. The external covering for the accelerator 12 is provided by horizontal rows of panels 16,16 of the present invention stacked vertically with sixteen (16) panels in each row and twenty-four (24) horizontal rows of panels. In the aggregate, the panels 16,16 provide a smooth continuous external front surface throughout for the accelerator 12 which separates wind engaging the same into two discrete horizontally diverging and accelerating streams of air respectively directed to the turbines 14,14 on opposite sides of the accelerator. A small motor 18 and an associated spur and annular rack gear system 20 is controlled by a wind direction sensor, not shown, to maintain the accelerator in a most efficient position for the reception of the wind by the turbines 14,14.

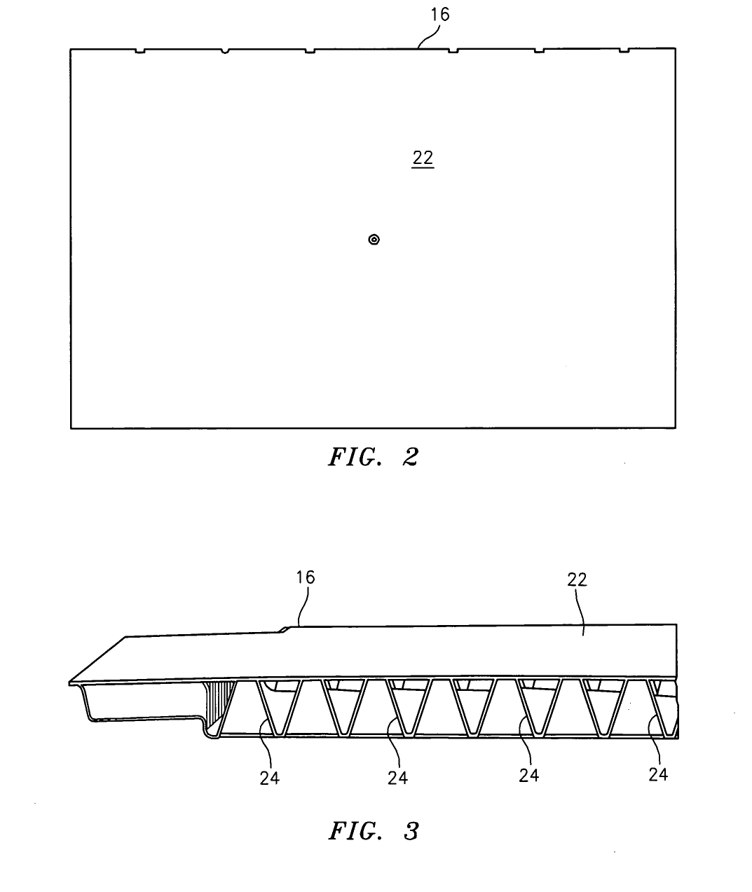

In FIG. 2 a panel 16 is shown in plan view and takes a preferred large monolithic substantially rectangular configuration. The panel shown is approximately eight and one half (8.5) feet long and five (5) feet wide and overall thickness is approximately one and one fourth (1.25) inches. As mentioned, the exterior surface 22 of the panel is smooth and continuous for uninterrupted wind flow thereover and the interior panel surface has a multiplicity of small strengthening projections 24,24 best shown in FIG. 3, preferably taking the form of small cones.

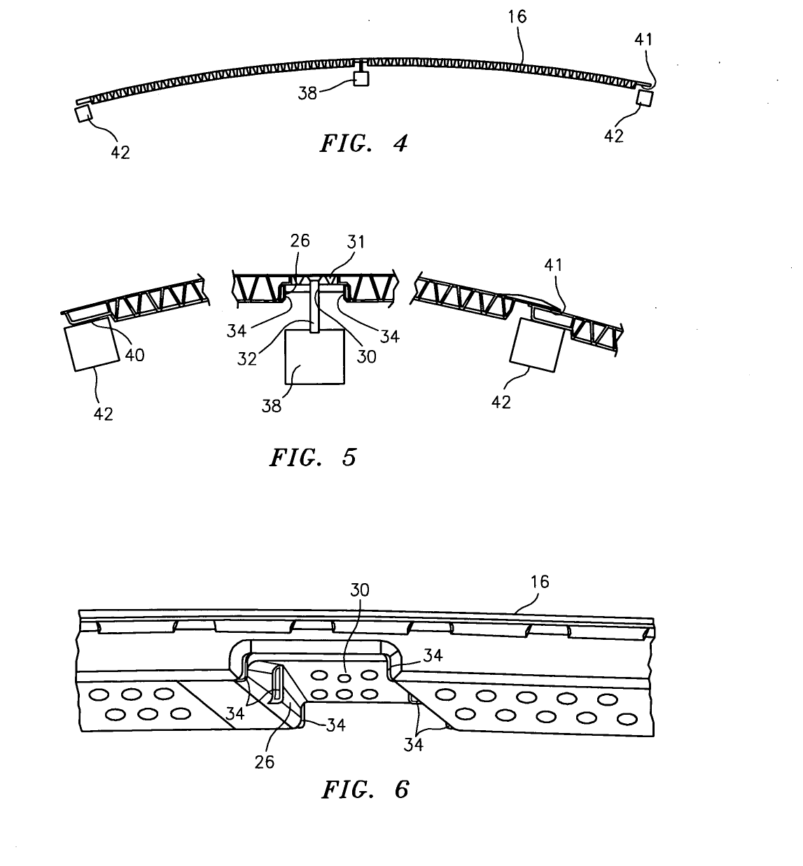

As stated, the panels 16,16 are manufactured with a slightly greater curvature than in the installed condition. Referring to FIG. 4, a panel 16 is shown prior to installation with a slight excess curvature. At a central location, the panel 16 is provided with a notch 26 for receiving a structural member 38 of the accelerator, FIGS. 4, 5 and 6. Centrally located in the notch 26 is a single through opening 30 provided with a grommet 31, for receiving a bolt 32. The bolt 32 is the only positive connection between the panel and the structure of the accelerator 12. As best seen in FIG. 6, six (6) small spaced projections 34,34 on the walls of the notch 26 provide for a press fit of the structural member 38 in the notch 26. Preferably notches 40,41 are also provided at opposite ends of the panel 16 for receiving structural members 42,42. The members 42,42 position the ends of the panels precisely against the flexing force of the latter, a left hand edge portion of an adjacent panel being inserted between the structural member 42 and the base of the notch in the right hand notch 41 which is substantially deeper than the left hand notch 40.

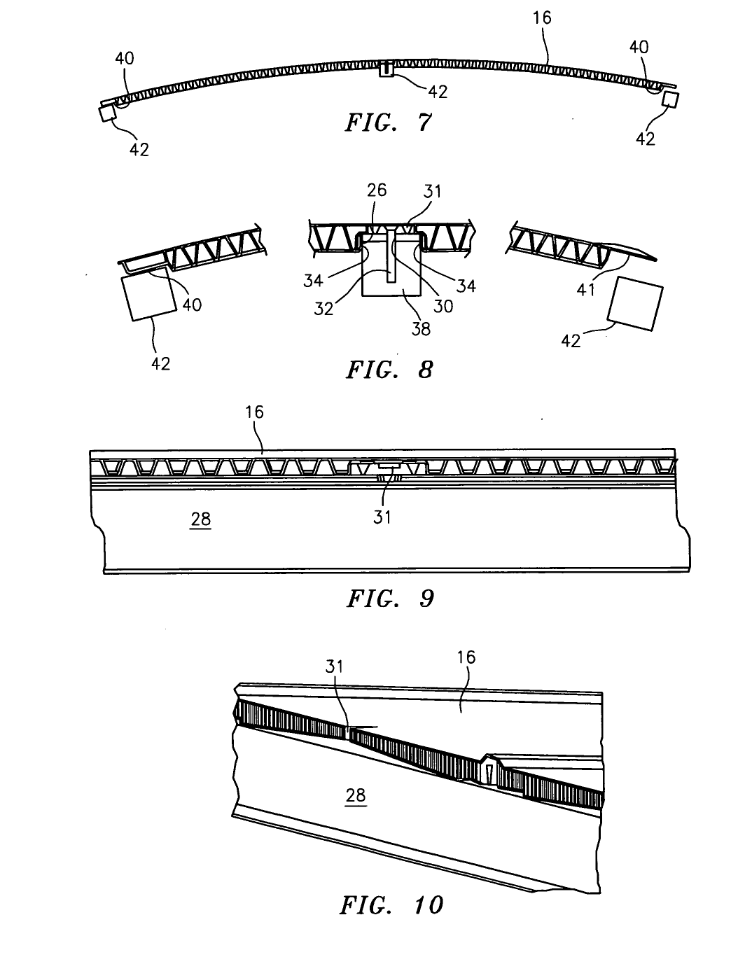

FIGS. 7, 8 and 9 show the panel 16 in position on and supported by the structural member 38.

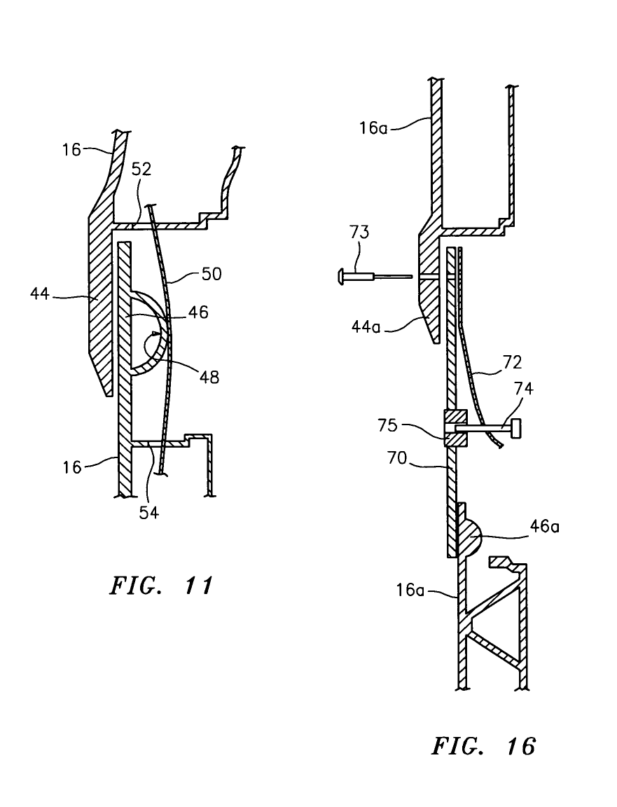

In FIGS. 10 and 11 overlapping vertical edge portions 44,46 of the panels 16,16 are shown with the edge portion 46 provided with a small boss 48 on its interior surface. The boss 48 is engaged by an anti-rattle spring clip 50 at a central portion of the latter with end portions of the clip entered in openings 52,54 respectively in end portions of the panels adjacent the edge portions 44,46. The spring clip 50 is maintained in a slightly flexed condition to insure a tight fit between the panel edge portions 44,46 and thus prevent intermittent airflow inwardly and resulting rattle.

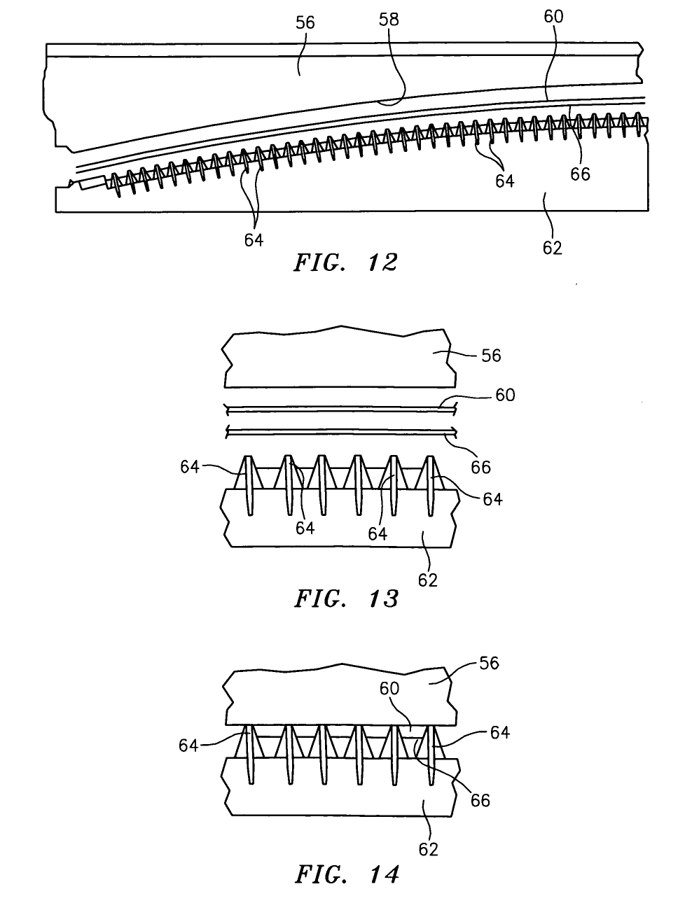

FIG. 12, 13 and 14 show the mold employed in the manufacture of the panels 16,16 and it will be noted that an upper mold half 56 has a gradually arcuate smooth lower surface 58 for forming the exterior surface of a first sheet of thermoplastic 60 which may be extruded or otherwise prepared. A lower mold half 62 has a multiplicity of small projections 64,64 for forming cones on the lower surface of a second sheet of plastic 66 and for fusing and forming the two sheets of plastic into a single integral panel 16 of large monolithic unitary construction in a rectangular or other configuration. This method of molding is known generically as “twin-sheet thermoforming” and results in a panel 16 of the highest possible strength to weight ratio. The presently preferred plastic is high-density high-molecular weight polyethylene.

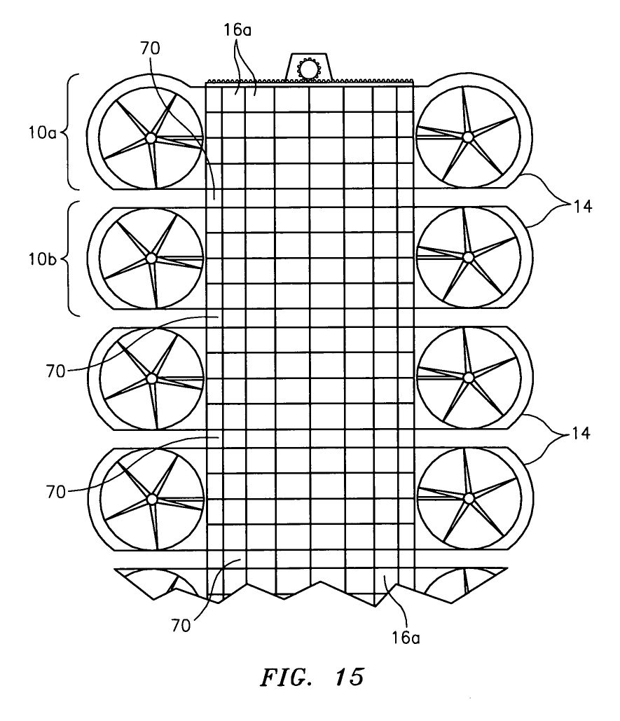

FIG. 15 shows a portion of a sectional cylindrical accelerator having four (4) rows of panels 16a, 16a in a cylinder section indicated generally at 10a. The accelerator section 10a carries two pairs of wind turbines 14a, 14a and is mounted vertically above a second section 10b with a small vertical gap between the two sections.

The spaces between sections of accelerators of the type shown in FIG. 15 may be filled by rows of joint panels 70,70 of the type shown in FIG. 16. The panel 70 extends between panel edge portions 44a and 46a, overlapping the edge portion 46a and in turn overlapped by the edge portion 44a. A rivet 73 or other connecting means is employed to connect the panel 70 to the edge portion 44a and to one end of a spring clip 74; the latter having its opposite end connected to the panel 70 at a central portion by a bolt 74 and a nut 75. As will be apparent, the bolt 74 may be tightened to draw the panel 70 and the clip 72 toward engagement and to urge the end portion of the panel 70 against the edge portion 46a thus completing a tight closure of all joints between the panel 70 and vertically adjacent panels 16a 16a.

From the foregoing it will be apparent that an improved panel of minimum weight and maximum strength characteristics has been provided as a result of a novel thermoforming method of manufacture. This results in a lightweight accelerator of desirably large cylindrical configuration capable of mounting a large number of wind turbines in a highly efficient wind turbine electrical generating system.

1. The combination in a wind power electrical generating system of a tower for supporting wind turbines at elevated positions for enhanced wind velocities, an accelerator mounted on said tower at an elevated position and comprising a vertically elongated generally cylindrical assembly adapted to divide wind impinging thereon into a pair of discrete relatively diverging streams of air flowing around opposite sides thereof, a plurality of pairs of similar wind turbines rotatable about substantially parallel horizontal axes mounted on opposite sides of said accelerator respectively to receive and extract energy from said two streams of air, said accelerator having an exterior covering comprising a multiplicity of similar large monolithic high strength but light weight individual panels of twin-sheet thermoformed construction arranged in series in horizontal rows stacked vertically, each panel being gradually arcuate and convex facing outwardly and secured in position by a single small centrally located connecting means to accommodate lateral expansion and contraction due to temperature variation, and each panel having narrow elongated edge portions of substantially reduced thickness in overlapping relationship with adjacent panels to accommodate relative sliding action with the adjacent panels for full panel expansion and contraction and for minimum departure from smooth and continuous wind directing external panel surfaces.

2. The combination as set forth in claim 1 wherein means are provided to center each panel and prevent rotation thereof about its connecting means.

3. The combination as set forth in claim 1 wherein the panels are provided initially with a slightly more severe curvature than required when mounted on the supporting structure of the tower so as to be flexed when so mounted and thus tightly engaging its supporting structure and adjacent panels at their edge portions for smooth air flow there over.

4. The combination as set forth in claim 1 wherein each panel has a multiplicity of small projections on its interior surface to enhance its structural integrity.

5. The combination as set forth in claim 4 wherein the projections are generally cone shaped.

6. The combination as set forth in claim 2 wherein a notch is provided on the interior surface of the panel to receive and fit a structural member, which supports the panel on the tower.

7. The combination as set forth in claim 6 wherein at least three small spaced apart projections are provided with at least one on a first side of the panel notch and with at least two on an opposite side for firm engagement with the structural member and for prevention of relative rotation of the panel.

8. The combination as set forth in claim 6 wherein second and third notches are provided respectively at opposite ends of the interior surface of the panel each in spaced relationship with the first notch, the second and third notches accommodating second and third structural members with provision for panel expansion and contraction and with resistance to panel stressing for firm engagement with the structural member.

9. The combination as set forth in claim 1 wherein the accelerator comprises a plurality of similar cylindrical sections stacked vertically and each carrying at least one pair of wind turbines on opposite sides thereof.

10. The combination as set forth in claim 9 wherein the cylindrical sections of the accelerator have vertical spaces between their covering panels, and wherein joint panels are provided in horizontal rows to cover the spaces.

11. The combination as set forth in claim 10 wherein the joint panels have spring clips attached thereto and are slidably connected at opposite ends with adjacent panels with central portions thereof engaging bosses on one of the adjacent panels so as to be flexed and thereby secure the two panels firmly together.

12. A large monolithic twin-sheet thermoformed panel for use as a wind engaging arcuate convex exterior covering on a generally cylindrical accelerator mounted at an elevated position on a tower supports at least one pair of wind turbines for generating electricity; said panel having a smooth continuous exterior surface for engaging the wind and directing the same in separate streams of air toward the turbines, an interior surface comprising a multiplicity of small projections enhancing the structural integrity of the panel, narrow elongated edge portions on all sides of substantially reduced thickness overlapping like edge portions of adjacent panels, at least one notch for receiving and tightly fitting a structural mounting member and preventing relative rotation of the panel, and a single centrally located means for fixedly mounting the panel on the structural member so as to accommodate full expansion and contraction of the panel.

13. A thermoplastic panel as set forth in claim 12 wherein second and third notches are provided respectively at opposite ends of the interior surface of the panel each in spaced relationship with the first notch, the second and third notches accommodating second and third structural members with provision for panel expansion and contraction and with resistance to panel stressing for firm engagement with the structural member.

14. A thermoplastic panel as set forth in claim 12 wherein at least three small spaced apart projections are provided with at least one on a first side of the panel notch and with at least two on an opposite side for firm engagement with the structural member and for prevention of relative rotation of the panel.

15. A thermoplastic panel as set forth in claim 12 wherein a central bolt opening is provided as said mounting means, and wherein an annular flange means is provided to support the panel and to recess the head of a bolt entered in said bolt opening so as to provide a smooth uninterrupted wind flow surface on the exterior of the panel.

16. A thermoplastic panel as set forth in claim 12 wherein the small projections on the interior surface of the panel are generally cone shaped.

17. A thermoplastic panel as set forth in claim 16 wherein the panel is substantially rectangular with approximately fifty (50) rows of projections in one direction and approximately eighty two (82) rows in the other direction.

18. A method of forming a large monolithic lightweight thermoplastic panel comprising the steps of positioning a pair of similar large blank sheets of thermoplastic in the shape of the panel in parallel face-to-face relationship between first and second thermal forming molds, vacuum drawing and thermoforming the sheets so that a first sheet has a smooth continuous external surface and a second sheet has a multiplicity of small spaced apart projections substantially throughout the side opposite the first sheet, the projections on the second sheet being simultaneously fused with the first sheet to form an integral monolithic final panel which is lightweight yet exhibits a high degree of structural integrity.

19. A method as set forth in claim 18 wherein the projections take substantially a cone shape.

20. A method as set forth in claim 19 wherein there are approximately sixty rows of cones in one direction and approximately one hundred and four rows of cones in the other direction.

21. A method as set forth in claim 18 wherein the plastic is polyethylene.

22. A method as set forth in claim 21 wherein the plastic is high-density high molecular weight polyethylene.

23. A method as set forth in claim 18 wherein a central notch is formed in the second sheet with a through bolt hole centrally located in both sheets.

24. A method as set forth in claim 23 wherein at least two spaced apart small projections are molded in each wall of the notch for a press fit engagement with a structural member entered in the notch.

25. A method as set forth in claim 18 wherein second and third notches are formed in the second sheet of plastic in spaced relationship with the first notch.

26. A method as set forth in claim 18 wherein each edge portion of the panel is formed with an elongated portion of reduced thickness.
